(19) United States
(12) Patent Application Publication
(10) Pub. No.: US 2006/0098116 A1
(43) Pub. Date: May 11, 2006

(54) Digital camera having alternate functional covers

(75) Inventors: Joseph A. Manico, Rochester, NY (US); David R. Scott, Brockport, NY (US); John R. Fredlund, Rochester, NY (US); Kenneth A. Parulski, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/985,379

(22) Filed: Nov. 10, 2004

(51) Int. Cl. H04N 5/225; H04N 5/222; G03B 17/00

(52) U.S. Cl. 348/373; 348/333.06

(57) ABSTRACT

A digital camera having a body and a detachable hinged cover for covering at least a portion of a display on the body, the detachable hinged cover capable of being placed in a first closed position and a second position, the cover and body forming an electrical connection between the cover and the body for providing an ancillary function by the cover to the body. A docking device for receiving the digital camera may be provided wherein an electrical connection is provided with another connector on the camera body.

### FIELD OF THE INVENTION

The present invention is directed to a digital camera having replaceable hinge cover that protects the camera's large display screen and that can also be used for providing alternate functions.

### BACKGROUND OF THE INVENTION

Digital cameras today are typically provided with a display for viewing of images that have been captured by the camera. These displays are continuously getting larger, however, they are subject to being accidentally damaged due to their relatively larger nature. Also as the displays become larger and the camera portions remain the same size or become smaller, the displays become an increasingly larger portion of the camera. Thus, it is desirable to provide a cover for protecting the display from accidental damage. Digital cameras are also limited to the functional features at the time of manufacturing of the camera originally obtained.

### SUMMARY OF THE INVENTION

The present invention is directed to an improved digital camera that not only allows protecting of the display screen, but also allows the camera to be easily modified to provide new, additional and/or updated functions and features. This is accomplished by providing the camera with a replaceable cover that cannot only protect the display, but also provides the ability to easily modify the camera to provide a multitude of additional and/or new functions.

In accordance with one aspect of the present invention there is provided a digital camera having a body and a detachable hinged cover for covering at least a portion of a display on the body, the detachable hinged cover capable of being placed in a first closed position and a second position, the cover and body forming an electrical connection between the cover and the body for providing an ancillary function by the cover to the body.

In accordance with another aspect of the present invention there is provided a digital camera and docking system, comprising:
a digital camera having a body having a plurality of electrical connectors and a detachable hinged cover having a mating connector for connecting to one of the plurality of electrical connectors, the cover capable of covering at least a portion of a display on the body, the detachable hinged cover capable of being placed in a first closed position and a second position, the cover and body forming an electrical connection between the cover and the body for providing an ancillary function by the cover to the body; and
a docking device for receiving the digital camera and providing electrical connection therewith one of the plurality of connectors on the camera body.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a rear view of a dockable digital camera made in accordance with the present invention;

FIG. 2a is a cross sectional side view of the dockable digital camera of FIG. 1 illustrating two electrical interface connectors located on the rotatable cover mount and a third electrical interface connector located on the camera body and the camera rotatable detachable cover in the position for covering the camera display;

FIG. 2b is a cross sectional side view of the detachable cover of FIG. 2a.

FIG. 3 is a bottom view of the dockable digital camera of FIG. 1;

FIG. 4 is a perspective view of the digital camera of FIG. 1 mounted on a camera docking device;

FIG. 5 is a perspective view similar to FIG. 4 illustrating the camera removed from the camera docking device;

FIG. 6 is a rear view of an alternative dockable digital camera made in accordance with the present invention;

FIG. 7 is a cross sectional side view of the dockable digital camera;

FIG. 8 is a bottom view of the alternative dockable digital camera of FIG. 6;

FIG. 9 is a perspective view of the camera of FIG. 6 illustrating the camera mounted to a camera docking device;

FIG. 10 is a perspective view similar to FIG. 9 illustrating the camera removed from the camera docking device;

FIG. 11 is a rear view of yet another alternative dockable digital camera made in accordance with the present invention;

FIG. 12 is a cross sectional side view of the dockable digital camera FIG. 11;

FIG. 13 is a bottom view of the dockable digital camera of FIG. 11;

FIG. 14 is a perspective view of the modified camera of FIG. 11 mounted on a modified docking device made in accordance with the present invention;

FIG. 15 is a perspective view similar to FIG. 14 illustrating the camera removed from the modified docking device;

FIG. 16 is a perspective view of an attachable keyboard that can be mounted to a dockable camera made in accordance with the present invention;

FIG. 17 is a perspective view of an attachable solar power supply/battery charger that can be mounted to a dockable camera made in accordance with the present invention;

FIG. 18 is a perspective view of an attachable auxiliary hard drive that can be mounted to a dockable camera made in accordance with the present invention;

FIG. 19 is a perspective view of the attachable keyboard of FIG. 16 illustrating a support assembly for use in the deployed position;

FIG. 20 is a side view of an attachable keyboard of FIG. 19 with support assembly in the deployed position;

FIG. 21 is a perspective view of an attachable keyboard of FIG. 20;

FIG. 22 is a perspective view of a cover and camera made in accordance with the present invention mounted wherein the cover has a deployable mounted assembly in the undeployed position;

FIG. 23 is a perspective view similar to FIG. 22 illustrating initial steps for deployment of the mounting assembly;

FIG. 24 is a side view of an attachable cover of FIGS. 22 and 23 illustrating the support assembly in the deployed position;

FIG. 25 is a perspective view of the camera and cover of FIG. 24;

FIG. 26 is a perspective view of an attachable keyboard with a deployable camera support assembly attached to a camera in the closed position;

FIG. 27 is a perspective view of an attachable keyboard with a deployable camera support assembly attached to a camera in the opened position;

FIG. 28 is a perspective view of an attachable keyboard with a deployable camera support assembly attached to a camera in the opened position and partially rotated; and

FIG. 29 is a perspective view of an attachable keyboard with a deployable camera support assembly attached to a camera in the opened position and partially rotated.

### DETAILED DESCRIPTION OF THE INVENTION

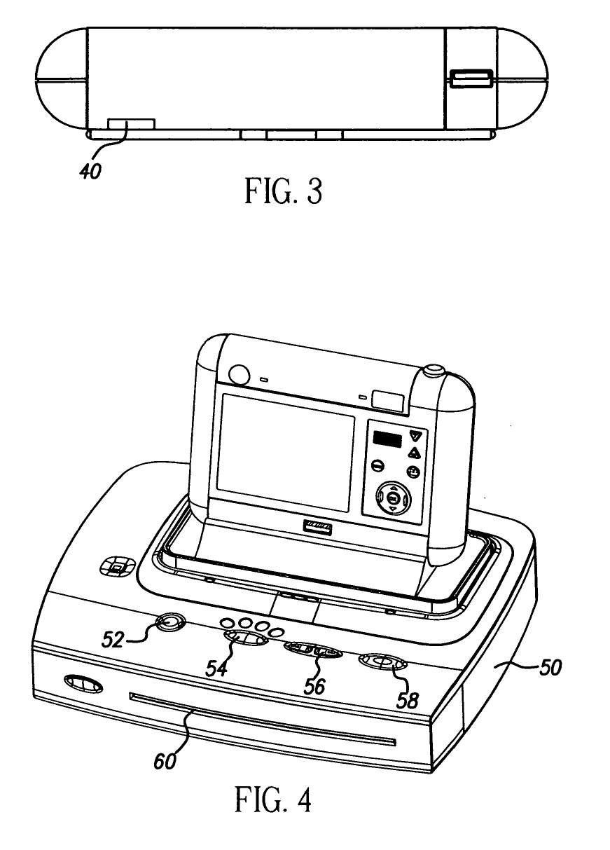

Referring to FIGS. 1-3, there is illustrated a digital camera 10 made in accordance with the present invention. The digital camera 10 body 12 includes a display screen 14 for illustrating the scene to be captured or that has been captured by the digital camera 10. The display screen may comprise any suitable display device, for example by not limited to, a Liquid Crystal Display (LCD), Light Emitting Display (LED) or OLED (organic light emitting display). As with all typical digital cameras, there is provided a plurality of functional user selection buttons and/or switches 16, 18, 20, 22, to control various functions of the digital camera 10 as is well known in the prior art. As is also typical with digital cameras, an image capture user switch 26 is provided where upon depression thereof by the user indicates the image to be captured by the digital camera 10. The camera 10 further includes a detachable hingeable cover 30 that is pivotally mounted to a rotating mounting member 32 in body 12 through the use of a pivot 34. The rotating mounting member 32 can rotate within the body 12 between various positions. The cover 30 in the position illustrated in FIGS. 1-3 is in the operating position for allowing capturing of digital images. The top end 36 is positioned at a point below position of the lens 40 and flash 24 for capturing of the image.

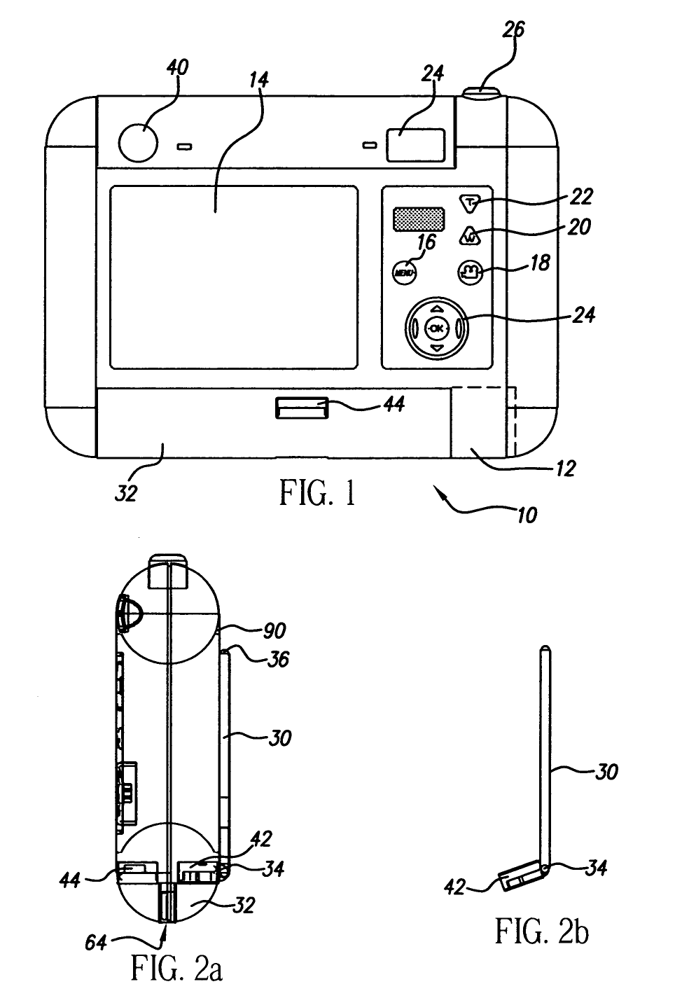

When it is desired to protect the display screen 14, the cover 30 is rotated to the position as illustrated in FIG. 2b. The cover may be opaque to match the style and color of the camera or may be transparent and made of a material like Plexiglas or Lexan to allow the screen to operate while being protected. The cover 30 is designed to provide additional features and/or functions to the camera 10. In the particular embodiment illustrated, the cover 30 is designed to provide additional power supply to the digital camera thereby extending the useful life of the digital camera 10 by supplementing any internal batteries the digital camera may have. Alternatively, the digital camera may not be provided with any internal battery, thus leaving the cover 30 to provide the primary source of electrical supply. While the embodiment illustrated in FIGS. 1-3, the cover 30 is illustrated as providing additional electrical capacity, the cover can be designed to provide a variety of functions for example, but not limited to, a keyboard, folding keyboard, a touch drawing tablet, a game controller, a solar collector, extended memory, additional memory card I/O slot types, lens viewfinder, a wireless computer I/O interface (including RF trans receiver), display porting, finger mouse, digital printer, cellular transceiver, or a TV receiver. A keyboard may be provided as a simple graphic that could be rolled up or folded for storage. When in use, the graphic keyboard would be placed adjacent to the camera and the camera's lens would be positioned to view the keyboard. By recording the positions of the user's fingers on the graphic keyboard, the camera's processor can interpret these finger locations as actual keystrokes.

Other accessory modules or attachments can be provided to enhance or alter the operation of the camera including an auxiliary light source such as an electronic flash, incandescent or LED lamps, deployable filters that would be positioned to operate in conjunction with lens and/or light source, additional lens attachments to provide special effects or provide additional close-up and magnification capabilities. Cover modules may also be provided with auxiliary displays, speakers, power, and memory that can be used to share images and videos captured with the camera. These ancillary display modalities may quire image content when attached to the camera or through wireless communication from the camera or another source.

Also, since the cover provides a relatively large area and adjustable mechanical attachment to the camera, accessory cover modules can be adapted to provide additional mounting options for the camera, such as a collapsible stand to provide “hands free” operation. In addition, modules may be provided to include collapsible mounting devices such as spring loaded adjustable grips or clamps, additional tripod mounts, pistol or hand grip, collapsible tripods, magnetic, and suction type mounts, all of which fit into the “X” and “Y” dimensions designated as a cover when in their “non-deployed” mode. The invention allows for different cover thicknesses in the “Z” dimension, varying depending on the physical requirements of the device of components. There are numerous examples on the market that combine variable geometry functionality and gripping capabilities. “All-in-one pocket tools” can contain a spring-loaded clamp or vise that can be folded back into the tool when not in use. In this mode the tool assumes a convenient rectangular shape to fit easily in a pocket. In addition the cover can contain a motorized “lazy Susan” pivoting mounting surface which would allow the camera to be remotely panned. This, in conjunction with a motorized rotary lens assembly and zoom lens, would allow full remote pan, tilt and, zoom capabilities. This can be enabled with a remote manual control or with an automatic tracking device such as an IR emitter. The user would wear the emitter on a lapel and the camera would be equipped with an IR receiver and control logic to enable the camera to track the user via the IR emitter signal. Automatic motorized panning and tilting tripods are well known.

An accessory cover can also function as a storage case for ancillary items such as connecting cables, additional camera batteries, memory devices, and other attachments and accessories. It is of course understood that the cover can provide any type of additional functions that can be exchanged through the use of the electrical connection there between. It may be desirable for some cover accessory types to only provide electrical contact with the camera when the cover is in operational position. In addition to providing additional electrical components, the cover can also be used for updating or supplementing the software that is currently provided on the digital camera 10. Thus, various different covers may be provided for providing additional functions other than what was originally obtained with the camera. A further example is that the cover may be designed to provide information for operating the camera in a particular language. Thus, all the information and translations necessary for operating of the digital camera can be easily maintained and changed by simply providing a cover having the appropriate software for communication with the internal software within the digital camera.

The cover 30 is provided with an electrical connector 42 (see FIG. 2b) for communicating electrical signals from components within cover 30 to the body 12. In the embodiment illustrated, the rotating mounting member 32 is provided with two electrical connectors 44, 46 for connecting with connector 42 so that electrical communication between components within the cover 30 is provided with internal components of the digital camera 10 as appropriate. In the embodiment illustrated, the connector 42 is a male connector designed to engage with female connectors 44, 46. The connectors 42, 44, and 46 are designed to easily engaged and disengaged as required. It is to be understood that any appropriate type connectors may be employed as required by the cover 30 and body 12, for example the connector may comprise USB type connector that allow communication to computers and power connections.

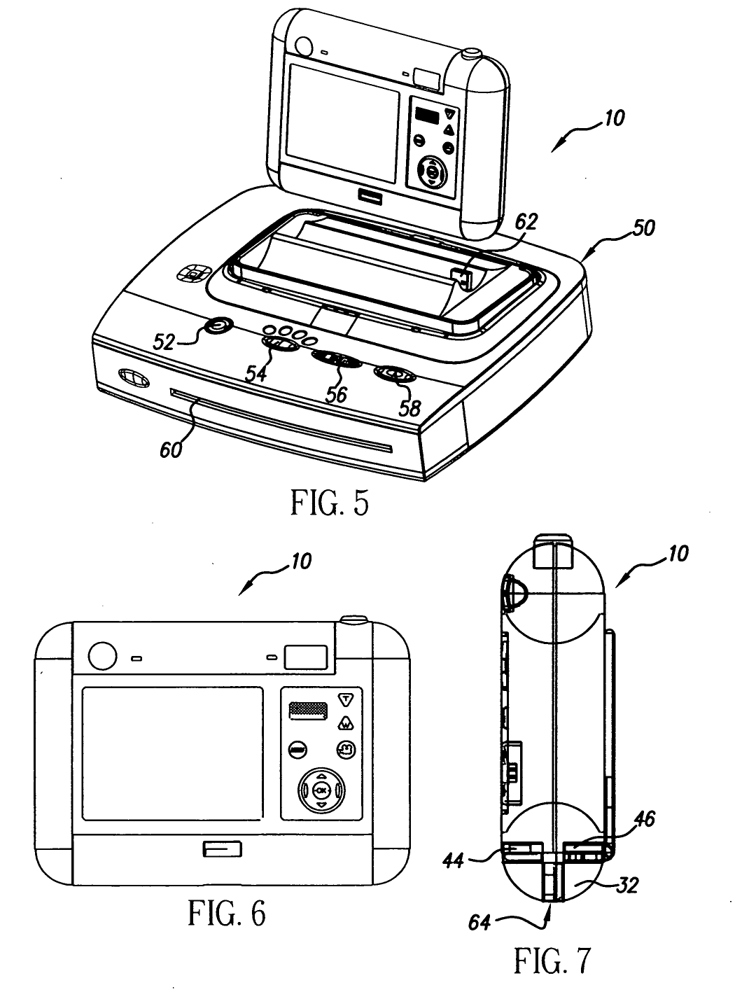

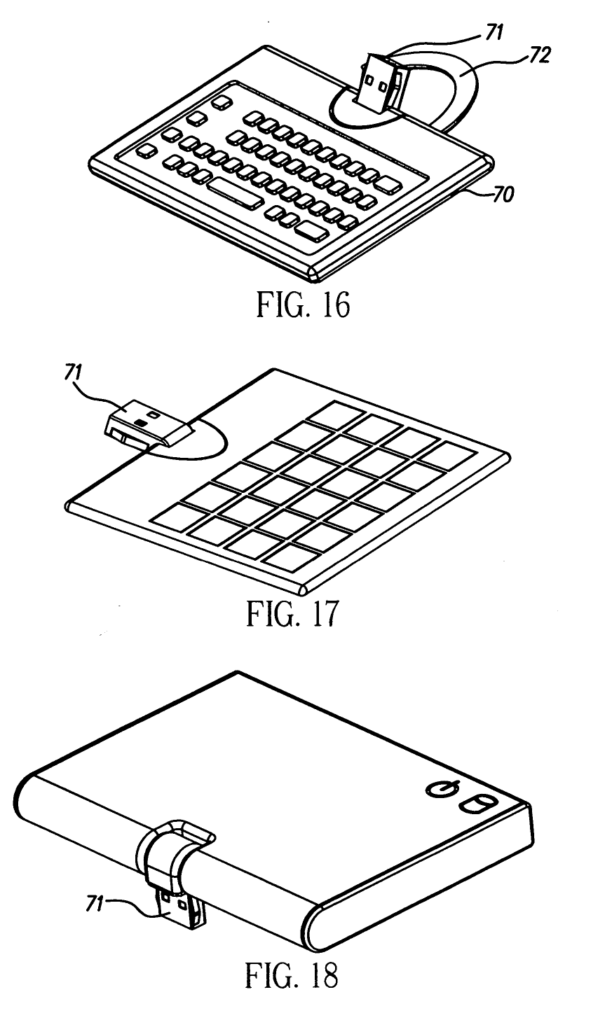

Referring to FIGS. 4 and 5, there is illustrated camera 10 positioned on a docking device 50. The docking device 50 may be used for a variety of different functions for example, but not limited to, the downloading of digital images from the camera 10 to the device 50 and then later to a PC or printer. In addition, the docking device may include additional memory devices and means such as hard drives and CD and/or DVD read/write components. Alternatively, the docking device 50 may contain appropriate printing features for printing digital images from the camera 10 directly onto a media. The docking device 50 is provided with appropriate user function selections buttons 52, 54, 56, 58 for controlling an operation of the docking device 50. In the embodiment illustrated, the docking device 50 is a printing device having an outlet 60 through which images printed on a media are dispensed. In addition, the docking device 50 includes an electrical port/connector 62 designed to provide electrical communication with electrical connector 64 provided in digital camera 10 (see FIG. 2a). The electrical connector 64 in the digital camera is provided in a position that is fixed on body 12 such that when the cover 30 is either in the position illustrated in FIG. 2a or FIG. 2b, the camera 10 may be docked on the docking device 50 for allowing communication between the docking device 50 and the digital camera 10. As illustrated in FIGS. 1-5, there are provided two connectors 44 and 46. The cover is generally connected to only one of the connectors 44 or 46, leaving the other connector available for connection with other devices or components either while the digital camera is on the docking device 50 or not on the docking device 50. For example, an attachable keyboard 70 may be connected as illustrated in FIGS. 16, 17 and 18 through the use of a suitable connector 72 provided on the keyboard 70. Various other attachable electrical devices may be provided for example, an attachable solar power supply/battery charger as illustrated in FIG. 17 or an attachable auxiliary hard drive as illustrated in FIG. 18. The docking device 50 may also be used to recharge the battery in the camera 10 or cover 30. Since the rotatable mounting member 32 can be rotated in either of the positions 2a or 2b, there will always be at least one connector available for connecting of these auxiliary devices.

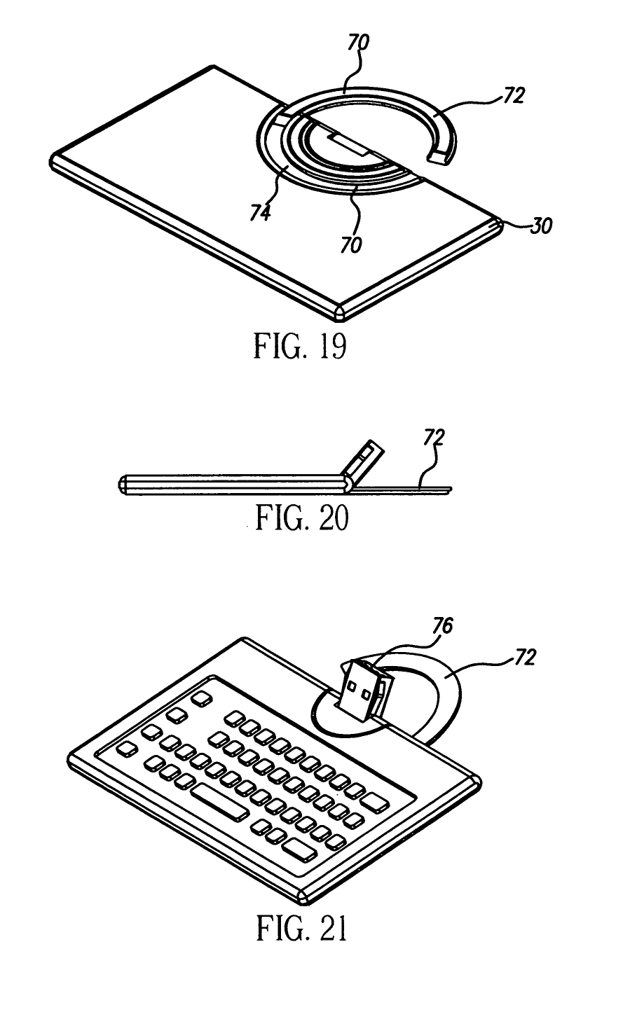

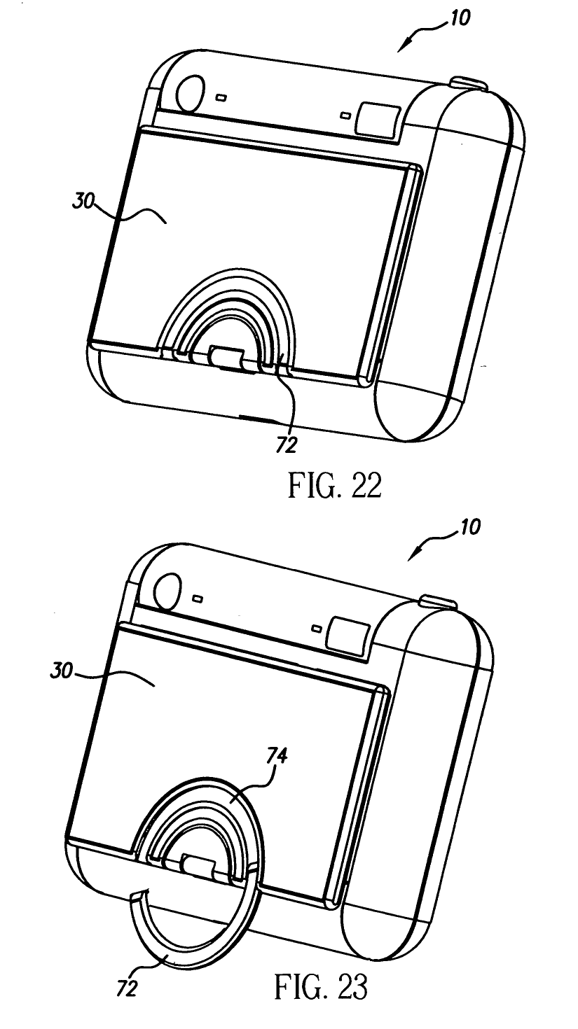

FIG. 19 is a perspective view of the attachable keyboard 70 of FIG. 16 wherein there is provided a slideable curved support member 72 which engages a correspondingly shaped recess 74 in cover 30 allowing the support member 72 to be positioned in the support position illustrated in FIG. 19 or in the non-use position illustrated by FIG. 22. In the extended position, as illustrated in FIGS. 20 and 21, the keyboard is supported to allow engagement of the projecting member 76 with the corresponding connector 44, 46 or 64.

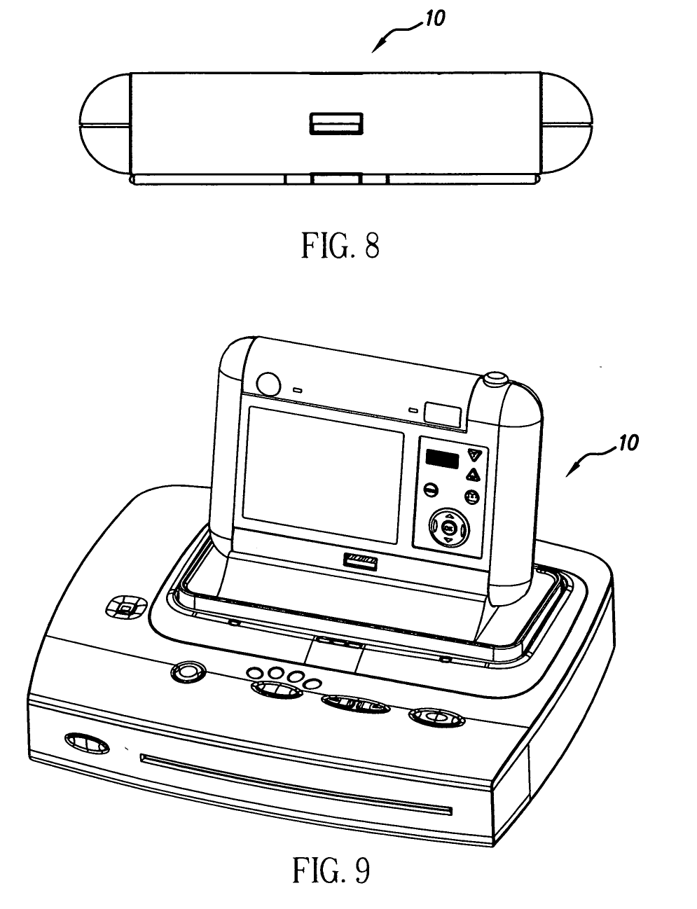

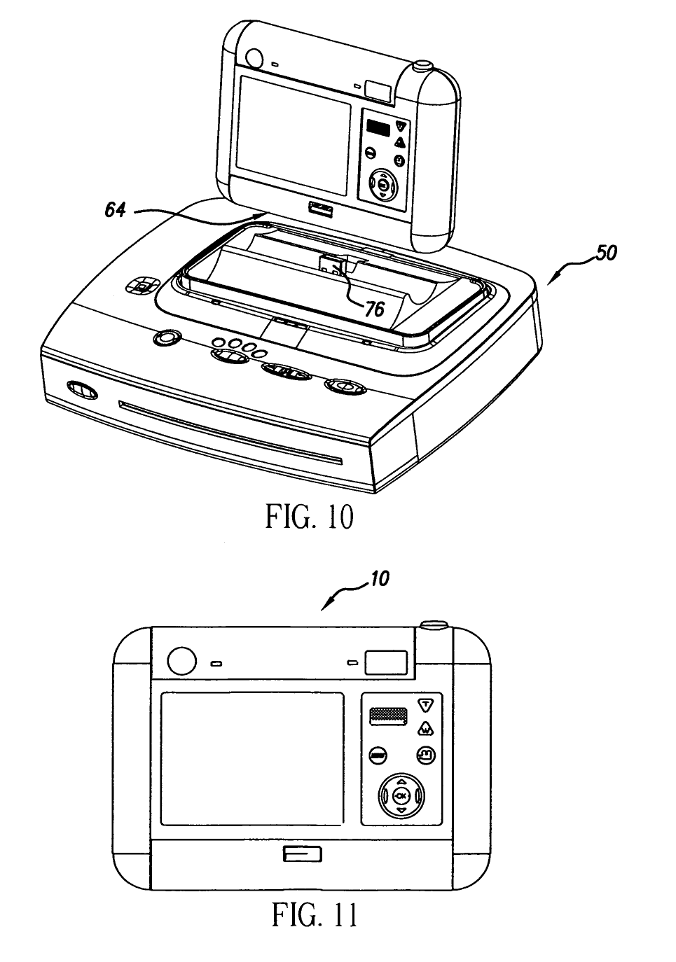

Referring to FIGS. 6, 7, 8, 9 and 10, there is illustrated a modified camera 10 made in accordance with the present invention and a docking device 50 also made in accordance with the present invention, like numerals indicating like parts and operation as previously discussed. In this embodiment, there are three connectors, 44, 46 and 64 which are all provided on the rotating mounting member 32 on camera 10. Thus, depending upon the rotational position of rotating mounting member 32, various connectors will be available for connecting with the cover and/or other auxiliary devices. As illustrated in FIG. 10, connector 76 in docking device 50 is designed to mate with the connector 64 in the center of the rotating mounting member 32.

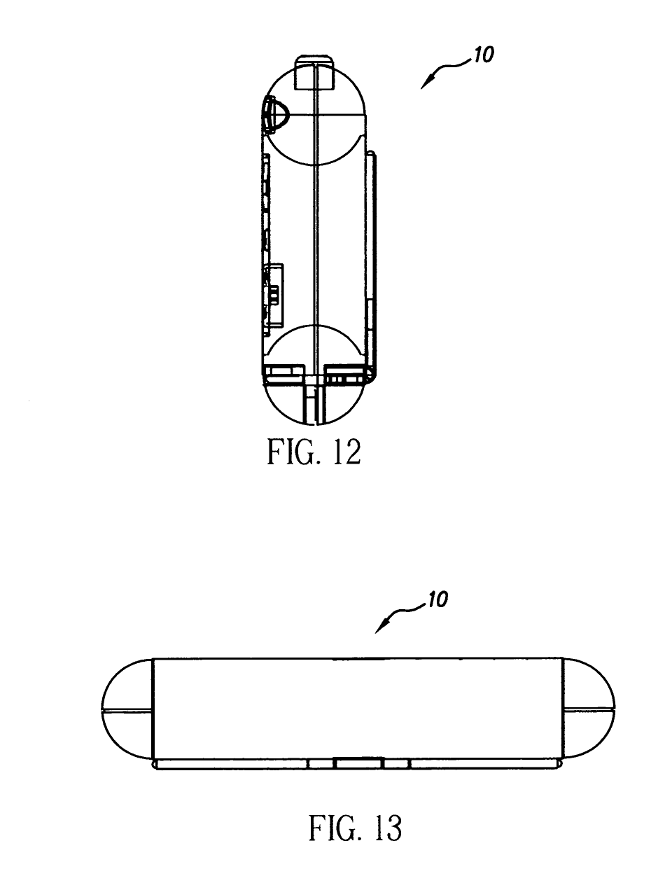

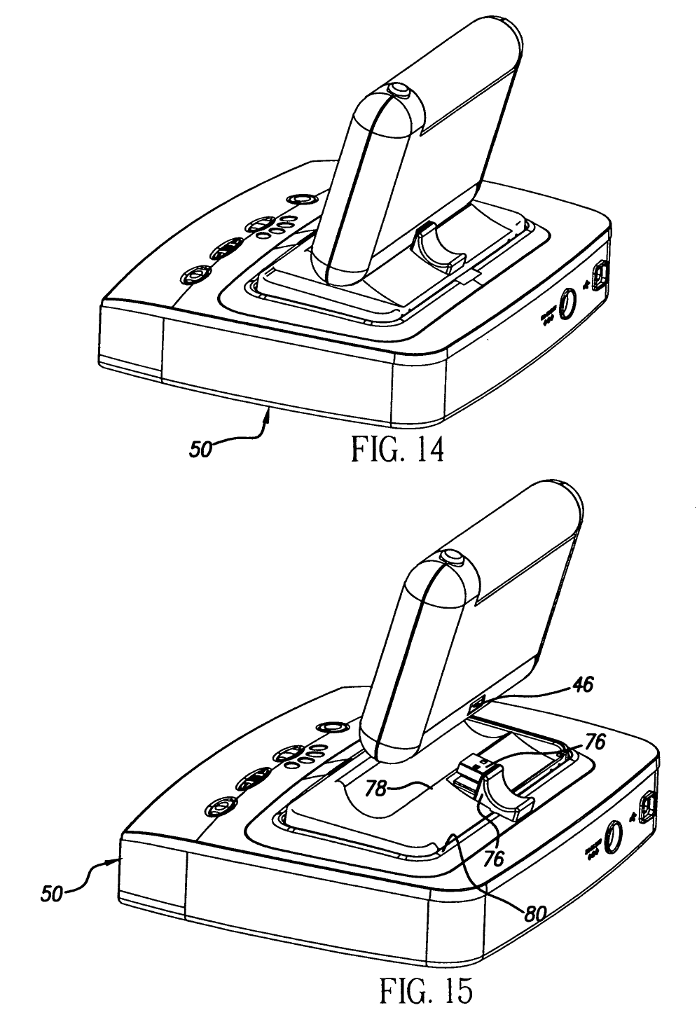

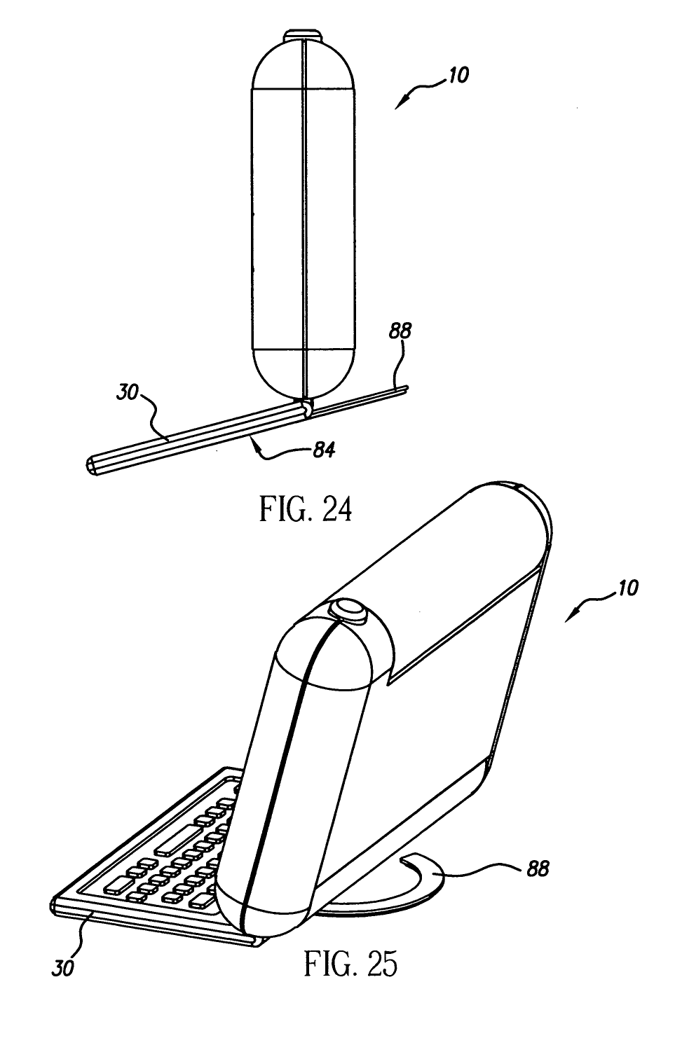

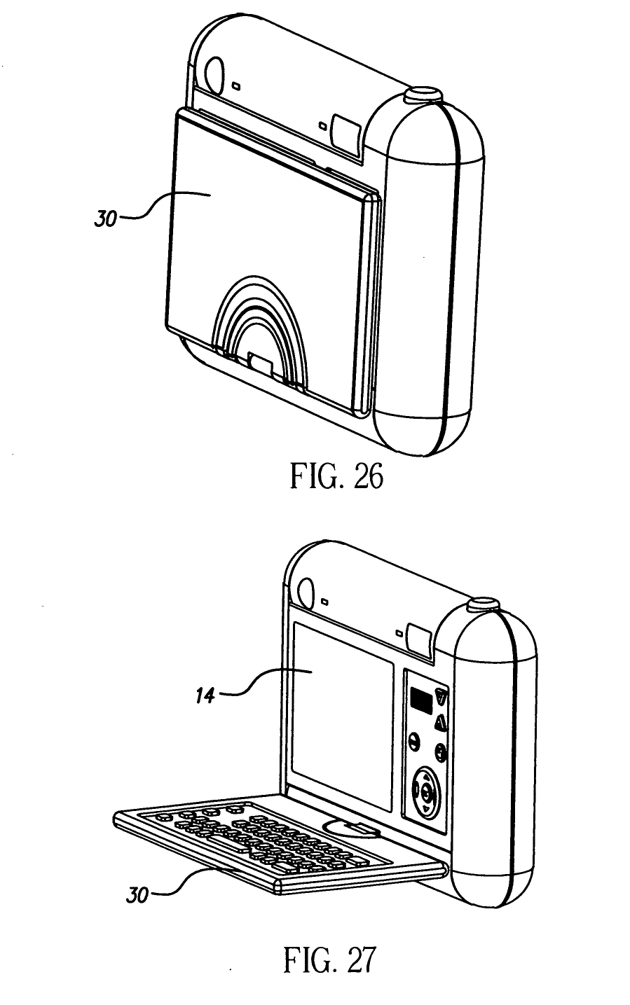

FIGS. 11-15 illustrate yet another modified form of the present invention, like numerals indicating like parts and operation as previously discussed. In this embodiment the docking device 50 has the main electrical connector 76 placed in the rear section 78 of the receiving cradle 80 and is designed to engage the connector on the front or back side of the rotating member 32 as opposed to the bottom portion as previously indicated. Here again, the projecting connector may be suitably connected to the appropriately positioned mating connector depending upon the position of the cover 30 on the digital camera 10. Thus, electrical connection can be maintained no matter if the cover is in a non protecting position of display screen 14 such as shown in FIGS. 2a, 7, 24, 25 or in the protection position as illustrated as shown in FIGS. 22 and 26

Referring to FIGS. 22-25, there is illustrated yet another modified embodiment digital camera 10 also made in accordance with the present invention. In this embodiment the cover 30 comprises an attachable keyboard having a self support feature for allowing placement of the digital camera on a support surface for allowing use of the keyboard and viewing of the digital display screen 14. In particular, the backside 84 of the cover 30 is provided with a slideable support member 88 similar to that of support member 77 like numerals indicating like parts in operation. In the position illustrated in FIGS. 23-25, the camera 10 may be placed in a position for use of the keyboard and visual display of the display screen 14.

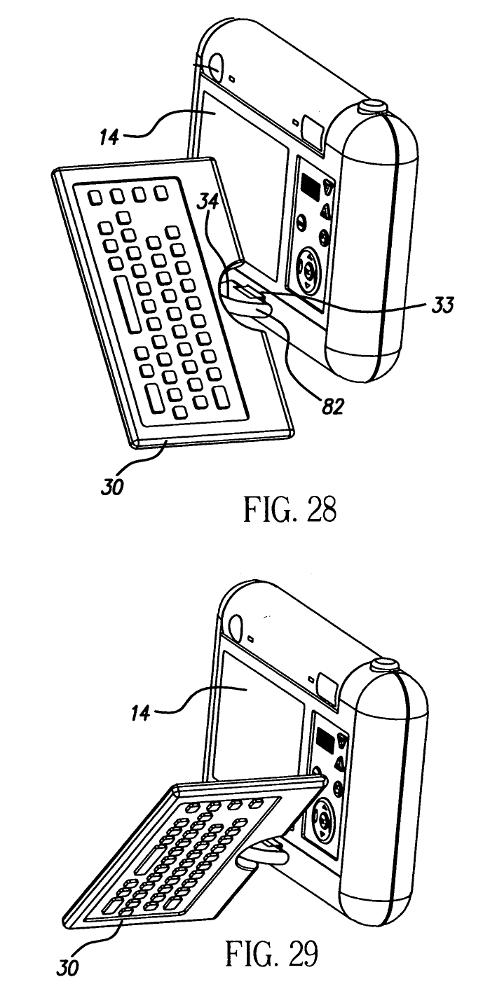

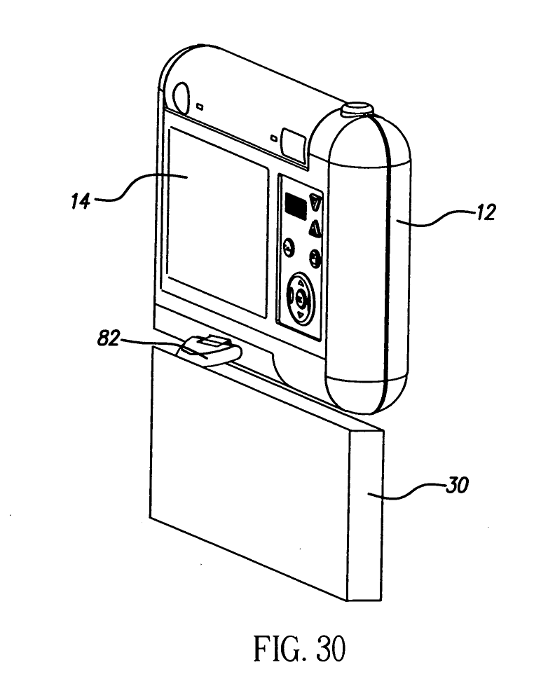

Referring to FIGS. 26-29 there is illustrated yet another cover 30 made in accordance with the present invention. In this embodiment, the cover 30 is rotatably mounted connector by a rotating mount member 82. The rotating mount member 82 also has a pivot 34 for allowing pivoting of the cover 30 about hinge 34. In this embodiment cover 30 is in the form of a keyboard. The rotating mount member 82 can rotate about connector 42 so that the cover 30 can be twisted and rotated as illustrated by FIGS. 28 and 29 thereby allowing the keyboard portion of cover 30 to face either the display screen 14 or the lens side of the camera 10. An example of a suitable mount member 82 would be a ball and socket type of connection. Appropriate electrical connections would be provided to allow communication with the camera 10 as is well known by those skilled in the art.

While in the embodiments illustrated, electrical contact and communication is provided by connectors 44, 46 and 64, wireless type communication or link between cover 30 and body 12 may be utilized where appropriate in place of the direct electrical connection. In such case, the cover 30 need only be secured to body 12 when needed and by any appropriate connection. Thus, for example, if only information is communicated between cover 30 and body 12, a wireless communication may be useful.

The cover 30 may also provide information as to identify the various types of functions and capabilities the cover 30 has so that the body 12 can appropriately respond to the cover's 30 functions and capabilities. For example, but not by way of limitation, the cover 30 may provide simple data type functions for providing data to body 12. The cover 30 may also provide various other camera mounting or photographic type functions and are not limited to the embodiments illustrated. The various cover functions may be passive or active functions with respect to body 12.

It is to be understood that various other changes and modifications may be made without departing from the scope of the present invention, the present invention being limited by the claims set forth herein.

The invention has been described in detail with particular reference to certain preferred embodiments thereof, but it will be understood that variations and modifications can be effected within the scope of the invention.

### PARTS LIST

10 digital camera
12 camera body
14 display screen
16 camera user selection button
18 camera user selection button
20 camera user selection button
22 camera user selection button
24 electronic flash
26 image capture user switch
30 detachable hingeable cover
32 rotating mounting member
34 pivot
36 camera top end
40 lens
42 male electrical connector
44 female electrical connector
46 emale electrical connector
50 docking device
52 docking device user function selection button
54 docking device user function selection button
56 docking device user function selection button
58 docking device user function selection button
60 printed media dispensing outlet
62 electrical port/connector
64 electrical connector
70 keyboard
72 connector
74 shaped recess
76 main electrical connector
77 support member
78 docking device rear section
80 receiving cradle
82 rotating mount member
84 cover backside
88 slideable support member

What is claimed is:

1. A digital camera having a body and a detachable hinged cover for covering at least a portion of a display on said body, said detachable hinged cover capable of being placed in a first closed position and a second position, said cover and body forming an electrical connection between said cover and said body for providing an ancillary function by said cover to said body.

2. A digital camera according to claim 1 wherein said cover provides a communication function to said digital camera.

3. A digital camera according to claim 1 wherein said cover comprises a battery for providing backup power to said digital camera.

4. A digital camera according to clam 1 wherein said cover provides additional digital memory storage to said camera.

5. A digital camera according to claim 1 wherein said electrical connection comprises a USB type connection between said cover and said body.

6. A digital camera according to claim 1 wherein said cover is secured to said body by a mechanical hinge.

7. A digital camera according to claim 1 further comprising a replaceable cover that provides additional updated information for use by said digital camera.

8. A digital camera according to claim 1 wherein said cover provides a mounting feature that allows securing of said camera to a variety of structures.

9. A digital camera according to claim 1 wherein said cover is detachably mounted to a rotatable mounting member in said camera body.

10. A digital camera according to claim 9 wherein said rotatable mounting member has a plurality of connectors for connection to a connector on said cover.

11. A digital camera according to claim 1 wherein said cover comprises a rotatable hinged cover that can rotate about said camera.

12. A digital camera and docking system, comprising:
a digital camera having a body having a plurality of electrical connectors and a detachable hinged cover having a mating connector for connecting to one of said plurality of electrical connectors, said cover capable of covering at least a portion of a display on said body, said detachable hinged cover capable of being placed in a first closed position and a second position, said cover and body forming an electrical connection between said cover and said body for providing an ancillary function by said cover to said body; and
a docking device for receiving said digital camera and providing electrical connection therewith one of said plurality of connectors on said camera body.

13. A digital camera and docking system according to claim 12 wherein said cover provides a communication function to said digital camera.

14. A digital camera and docking system according to claim 12 wherein said cover comprises a battery for providing backup power to said digital camera.

15. A digital camera and docking system according to clam 12 wherein said cover provides additional digital memory storage to said camera.

16. A digital camera and docking system according to claim 12 wherein said electrical connection comprises a USB type connection between said cover and said body.

17. A digital camera and docking system according to claim 12 wherein said cover is secured to said body by a mechanical hinge.

18. A digital camera and docking system according to claim 12 further comprising a replaceable cover that provides additional updated information for use by said digital camera.

19. A digital camera and docking system according to claim 12 wherein said cover provides a mounting feature that allows securing of said camera to a variety of structures.

20. A digital camera and docking system according to claim 12 wherein said cover is detachably mounted to a rotatable mounting member in said camera body.

21. A digital camera and docking system according to claim 9 wherein said rotatable mounting member has a plurality of connectors for connection to a connector on said cover.

22. A digital camera and docking system according to claim 21 wherein said rotatable hinged cover can also rotate about said camera.

23. A digital camera and docking system according to claim 12 wherein said docking device automatically down loads images from said camera.

24. A digital camera and docking system according to claim 12 wherein said docking device communicates with said cover and/or camera.

25. A digital camera and docking system according to claim 12 wherein said mounting member on said camera allowing any one of the plurality of connectors available for connections with said cover and docking device when said cover is placed over said display screen or when placed in the non protection position of said screen.

26. A digital camera having a body and a detachable hinged cover for covering at least a portion of a display on said body, said detachable hinged cover capable of being placed in a first closed position and a second position, said cover and body forming a communication link connection between said cover and said body for providing an ancillary function by said cover to said body.

27. A digital camera according to claim 26 wherein said cover provides a communication function to said digital camera.

28. A digital camera according to clam 26 wherein said cover provides additional digital memory storage to said camera.

29. A digital camera according to claim 26 wherein said communication link comprises a wireless type connection between said cover and said body.

30. A digital camera according to claim 26 wherein said cover is secured to said body by a mechanical hinge.

31. A digital camera according to claim 26 further comprising a replaceable cover that provides additional updated information for use by said digital camera.

32. A digital camera according to claim 26 wherein said cover provides a mounting feature that allows securing of said camera to a variety of structures.

33. A digital camera according to claim 26 wherein said cover is detachably mounted to a rotatable mounting member in said camera body.

34. A digital camera according to claim 33 wherein said rotatable mounting member has a plurality of connectors for connection to a connector on said cover.

35. A digital camera according to claim 26 wherein said cover comprises a rotatable hinged cover that can rotate about said camera.

36. A digital camera and docking system, comprising:
a digital camera having a body and a detachable hinged cover, said cover capable of forming a communication link with said body, said detachable hinged cover capable of being placed in a first closed position and a second position, said cover providing an ancillary function to said body; and
a docking device for receiving said digital camera and providing electrical connection therewith one of said plurality of connectors on said camera body.

37. A digital camera and docking system according to claim 36 wherein said cover provides a communication function to said digital camera.

38. A digital camera and docking system according to clam 36 wherein said cover provides additional digital memory storage to said camera.

39. A digital camera and docking system according to claim 36 wherein said communication link comprises a wireless type connection between said cover and said body.

40. A digital camera and docking system according to claim 36 wherein said cover is secured to said body by a mechanical hinge.

41. A digital camera and docking system according to claim 36 further comprising a replaceable cover that provides additional updated information for use by said digital camera.

42. A digital camera and docking system according to claim 36 wherein said cover provides a mounting feature that allows securing of said camera to a variety of structures.

43. A digital camera and docking system according to claim 36 wherein said cover is detachably mounted to a rotatable mounting member in said camera body.

44. A digital camera and docking system according to claim 43 wherein said rotatable mounting member has a plurality of connectors for connection to a connector on said cover.

45. A digital camera and docking system according to claim 43 wherein said rotatable hinged cover can also rotate about said camera.

46. A digital camera and docking system according to claim 36 wherein said docking device automatically down loads images from said camera.

47. A digital camera and docking system according to claim 36 wherein said docking device communicates with said cover and/or camera.
